(19) United States
(12) Patent Application Publication
(10) Pub. No.: US 2014/0009137 A1
(43) Pub. Date: Jan. 9, 2014

(54) SYSTEM, METHOD, AND COMPUTER PROGRAM PRODUCT FOR SINGLE WIRE VOLTAGE CONTROL OF A VOLTAGE REGULATOR

(71) Applicants: Gabriele Gorla, Santa Clara, CA (US); John Lam, Milpitas, CA (US); Joey Zhao, Shenzhen (CN)

(72) Inventors: Gabriele Gorla, Santa Clara, CA (US); John Lam, Milpitas, CA (US); Joey Zhao, Shenzhen (CN)

(73) Assignee: NVIDIA CORPORATION, Santa Clara, CA (US)

(21) Appl. No.: 13/541,616

(22) Filed: Jul. 3, 2012

(51) Int. Cl. G05F 3/02

(52) U.S. Cl. 323/304

(57) ABSTRACT

A system, method, and computer program product are provided for single wire voltage control of a voltage controller. A voltage controller is included and is in communication with a device, A single wire is connected between the voltage controller and the device for use by the device in controlling an output voltage of the voltage controller.

### FIELD OF THE INVENTION

The present invention relates to voltage regulators, and more particularly to controlling voltage regulators.

### BACKGROUND

Output voltage control of voltage regulators has conventionally been achieved via analog control, parallel digital control, or serial digital control. However, these techniques for providing voltage control have various limitations.

For example, in order to support multiple output voltage values via the analog control method, numerous wires and additional components are required from the voltage controlling device to the voltage regulator. The parallel digital control method also requires numerous wires, thus consuming valuable pins on the devices and area on the Printed Circuit Board (PCB). Alternatively, the typical serial digital control method reduces the number of wires, but adds complexity and cost to the voltage regulator and voltage controlling device in order to manage the various output voltage requirements.

Multiple output voltage values are generally related to the various modes of operation according to which the voltage controlling device may be configured to operate (e.g. a slow mode, an intermediate mode, a fast mode). The need for numerous wires has accordingly resulted in an increase of pins required on the package of both the voltage controlling device [e.g. graphics processing unit (GPU)] and the voltage regulator.

There is thus a need for addressing these and/or other issues associated with the prior art.

### SUMMARY

A system, method, and computer program product are provided for single wire voltage control of a voltage controller. A voltage controller is included and is in communication with a device. A single wire is connected between the voltage controller and the device for use by the device in controlling an output voltage of the voltage controller.

### BRIEF DESCRIPTION OF THE DRAWINGS

FIG. 1 shows a system for single wire voltage control of a voltage controller, in accordance with one embodiment.

FIGS. 2A-C show exemplary analog voltage controllers, in accordance with other embodiments.

FIG. 3 shows an exemplary digital voltage controller, in accordance with yet another embodiment.

FIG. 4 shows a graphical depiction of output voltage as a function of the control signals duty cycle, in accordance with still yet another embodiment.

FIG. 5 illustrates an exemplary system in which the various architecture and/or functionality of the various previous embodiments may be implemented.

### DETAILED DESCRIPTION

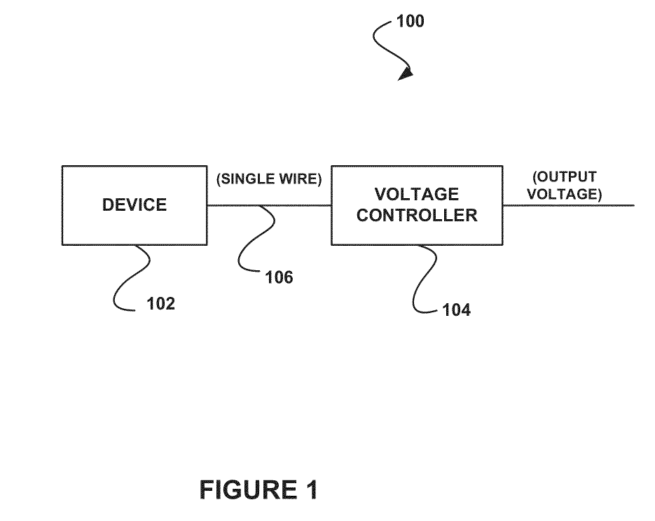

FIG. 1 shows a system 100 for single wire voltage control of a voltage controller, in accordance with one embodiment. As shown, a device 102 is in communication with a voltage controller 104 via a single wire 106. In use, the single wire 106 is for use by the device 102 in controlling the output voltage of the voltage controller 104.

In the context of the present description, the device 102 may be any control circuit capable of providing a control signal to the voltage controller 104 via the single wire, for controlling the output voltage of the voltage controller 104. For example, the device 102 may be a graphics processor (e.g. GPU), central processing unit (CPU), etc.

Further, in one embodiment, the control signal output by the device 102 over the single wire 106 may be a pulse width modulation (PWM) signal. In another embodiment, the control signal may be a modulated signal that controls the output voltage according to a percentage on/off time. Of course, however, the control signal may be any signal capable of being used for controlling the output voltage of the voltage controller 104. For example, the control signal may have an alternating high time and low time. Accordingly, the control signal may be a duty cycle that represents a percentage (i.e. ratio) of the high time to low time, where such duty cycle may control components of the voltage controller 104 to achieve a particular output voltage for the voltage controller 104.

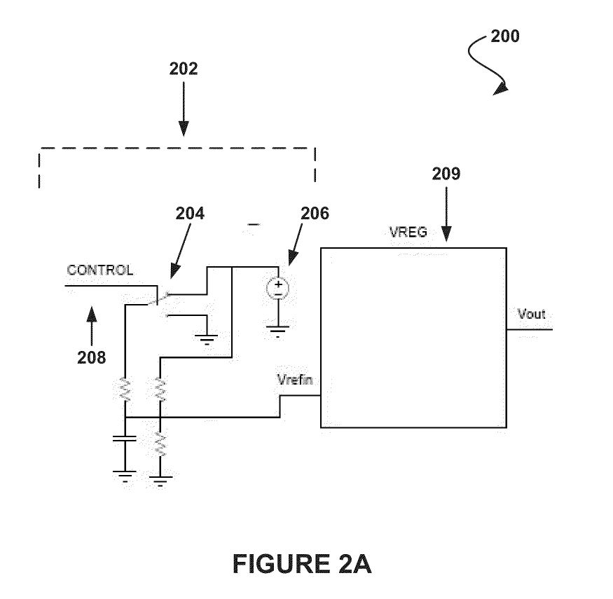

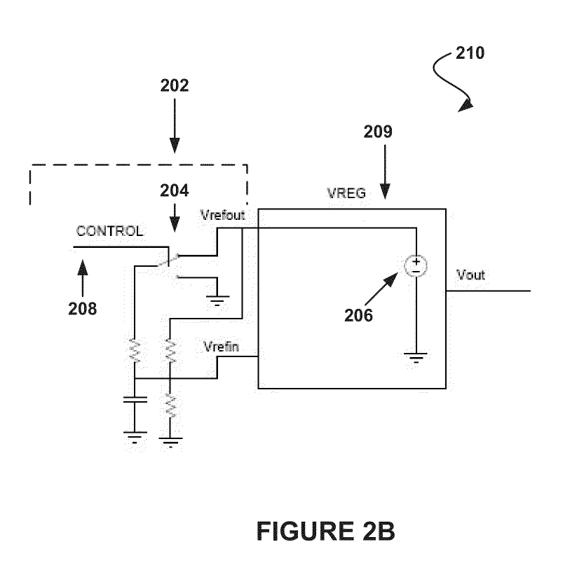

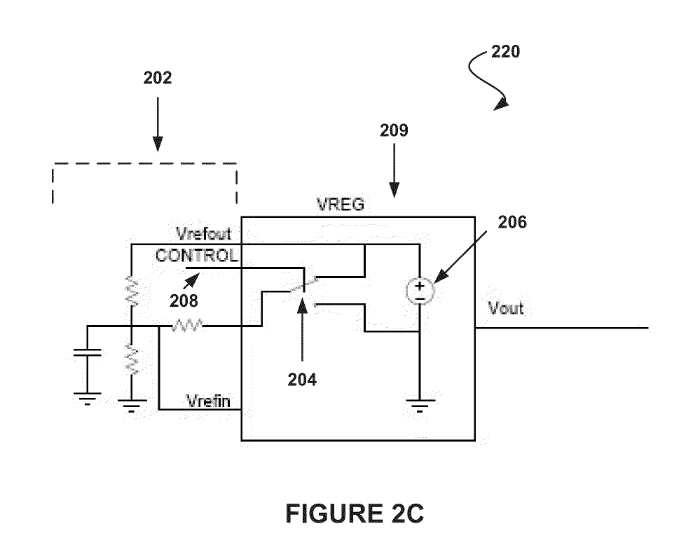

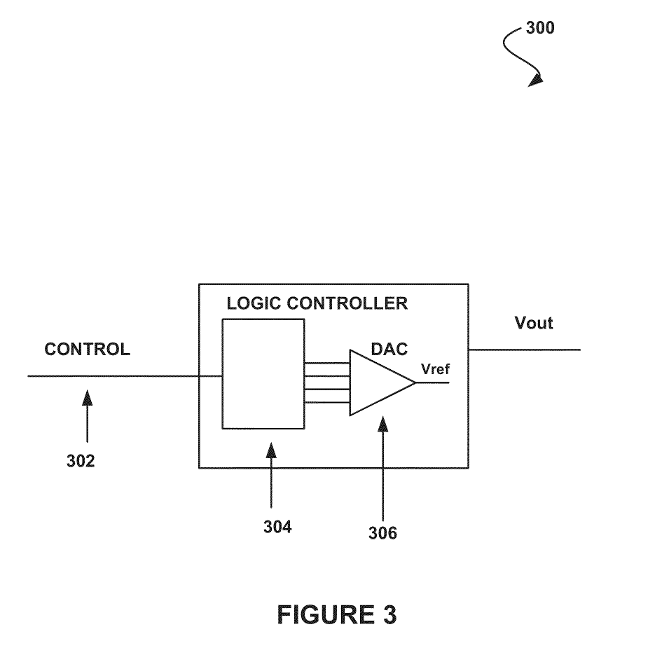

Also in the context of the present description, the voltage controller 104 may be any device capable of receiving as input the control signal via the single wire 106 for use in controlling the output voltage of the voltage controller 104. For example, the voltage controller 104 may translate the received control signal to a particular output voltage. In one embodiment, the voltage controller 104 may be or include an analog voltage controller, examples of which are described in more detail below with respect to FIGS. 2A-C. In another embodiment, the voltage controller 104 may be or include a digital voltage controller, an example of which is described in more detail below with respect to FIG. 3.

While not shown, it should be noted that the voltage controller 104 may include various sub-components, such as a circuit (i.e. digital or analog) and/or a voltage regulator. The voltage regulator may be utilized for regulating the output voltage of the circuit of the voltage controller 104.

As noted above, only a single wire 106 from the device 102 to the voltage controller 104 may be used to control the output voltage of the voltage controller 104. This may reduce the number of pins required on the package housing the voltage controller 104 which are required to be utilized by the device 102 for controlling the voltage controller 104 (i.e. to a single pin to which the single wire 106 is attached).

As an example of implementation of the above system 100, a percentage (i.e. ratio) of the control signal duty cycle may be utilized to determine the output voltage (Vout). With respect to such example, a minimum voltage (Venin) may be at a zero percent duty cycle and a maximum voltage (Vmax) may be at a one hundred percent duty cycle. In this way, the voltage range of the output voltage may be the maximum voltage at a one hundred percent duty cycle less the minimum voltage at a zero percent duty cycle (e.g. and may be a function of resistors included in the voltage controller 104).

Further, different output voltage values between the minimum voltage and the maximum voltage may be obtained at varying percentages of the duty cycle between the zero percent and the one hundred percent. For example, the output voltage value may be obtained as a function of a percentage (ratio) of the duty cycle. Such output voltage values may be incremental from the minimum voltage to the maximum voltage, and may increment at predetermined voltage steps (Vstep). Moreover, the resolution (i.e. size) of each of the voltage steps may be a function of the capabilities of the voltage controller 104. In addition, the device may be capable of adjusting the resolution of each voltage step.

Further to the example given above, the output voltage (Vout) may be determined by the equation shown in Table 1. Of course, it should be noted that the equation shown in Table 1 is set forth for illustrative purposes only, and thus should not be construed as limiting in any manner.

```
TABLE 1
Vout = Vmin + N*Vstep
  where:
    Vmin is a minimum voltage at a zero percent PWM duty
    cycle,
    N is a number of voltage steps at the output voltage, where
    the number of voltage steps is from zero towards a
    maximum number of available voltage steps, and
    Vstep is a resolution of each of the voltage steps.
```

Table 2 shows the values capable of being utilized by the device 102 for determining the high/low ratio of the control signal to be used in controlling the voltage controller 104. As shown, Table 2 assumes the voltage controller 104 includes three resistors, but of course in other embodiments, the voltage controller 104 may include any number of resistors, and the values capable of being utilized by the device 102 for determining the high/low ratio of the control signal may accordingly be calculated by varied equations. Again, it should be noted that the information provided in Table 2 is set forth for illustrative purposes only, and thus should not be construed as limiting in any manner.

TABLE 2

| | Output Voltage Equation | Description |
|---|---|---|
| Vmax | $VREF * \frac{R 2}{R 2 + ( R 1 \vert \vert R 3 )}$ | The output voltage of REFIN at one hundred percent duty cycle. |
| Vmin | $VREF * \frac{R 2 \vert \vert R 3}{R1 + ( R 2 \vert \vert R 3 )}$ | The output voltage of REFIN at zero percent duty cycle. |
| Vstep | $\frac{Vmax - Vmin}{Nmax}$ | The resolution of the voltage step. |
| Vout | Vmin + N * Vstep | The output voltage at REFIN. |
| Nmax | | Total available voltage step numbers. |
| N | | The step number at the specific Vout. |
| | | N/Nmax ratio equals duty cycle. |

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

FIGS. 2A-C show exemplary analog voltage controllers 200, 210, and 220, in accordance with other embodiments. As an option, the analog voltage controllers 200, 210, and 220 may be implemented in the context of the voltage controller 104 of the system 100 of FIG. 1. Of course, however, the analog voltage controllers 200, 210, and 220 may be implemented in any desired environment. It should also be noted that the aforementioned definitions may apply during the present description.

As shown in FIGS. 2A-C, the analog voltage controller 200, 210, and 220 includes an analog circuit sub-component 202 and a voltage regulator sub-component 209 While not shown, it should be noted that the control signal 208 input to the analog circuit sub-component 202 may be received from a device (e.g. device 102 of FIG. 1) via a single wire situated between the device and the analog voltage controller 200, 210, and 220.

The voltage controller 200, 210, and 220 includes a switch 204. FIGS. 2A-B show embodiments where the switch 204 is a component of the analog circuit sub-component 202. FIG. 2C shows an embodiment where the switch 204 is a component of the voltage regulator sub-component 209.

The switch 204 is controlled by the device (not shown) via the single wire. In particular, the switch 204 toggles according to the control signal provided to the switch 204 via the single wire. As shown, the switch 204 toggles a reference voltage 206, which may be provided by an external voltage reference of the analog circuit sub-component 202 (shown in FIG. 2A) or a voltage reference of the voltage regulator sub-component 209 (shown in FIGS. 2A-B) of the voltage controller 200, 210, and 220.

Accordingly, as shown, the switch 204 receives the reference voltage 206 and toggles an output of the reference voltage 206 according to the control signal 208. The switch 204 and associated resistor configuration determine the output voltage (Vout) of the voltage controller 200, 210, and 220. As noted above, the switch 204 toggles the output of the reference voltage 206 according to the control signal 208, such that the resistor configuration filters the reference voltage 206 outputted via the switch 204 to provide the output voltage.

In other embodiments, the voltage controller 200, 210, and 220 may include a buffer (not shown), for example, without the switch 204. Similar to the switch 204 described above, the buffer may toggle the reference voltage 206 according to the control signal 208. In this way, the resistor configuration may filter the reference voltage 206 outputted via the buffer to provide the output voltage.

The buffer may require a stable, high precision reference voltage 206, and the dynamic range of the voltage controller 200, 210, and 220 may be determined by the resistor selection. There may be some ripple voltage at the reference input (REFIN) due to the nature of the control signal 208 and filter. An error amplifier of the voltage controller 200, 210, and 220 may be able to tolerate a particular amount of ripple voltage, and may be sensitive to specific ripple voltage frequency ranges. For example, if the ripple is below two times a bandwidth of a control loop of the voltage controller 200, 210, and 220, the output voltage may be impacted. As another example, it may be sensitive to a size of the ripple voltage as well, such that an as an option the filter may be increased to suppress the ripple.

FIG. 3 shows an exemplary digital voltage controller 300, in accordance with yet another embodiment. As an option, the digital voltage controller 300 may be implemented in the context of the voltage controller 104 of the system 100 of FIG. 1. Of course, however, the digital voltage controller 300 may be implemented in any desired environment. Again, it should be noted that the aforementioned definitions may apply during the present description.

As shown, the digital voltage controller 300 includes a logic controller sub-component 304 and a digital to analog converter (DAC) sub-component 306. A control signal 302 is received as input to the logic controller sub-component 304 of the digital voltage controller 300. While not shown, it should be noted that the control signal 302 input to the logic controller sub-component 304 may be received from a device (e.g. device 102 of FIG. 1) via a single wire situated between the device and the digital voltage controller 300.

The logic controller sub-component 304 may be the digital component of the digital voltage controller 300, such that the logic controller sub-component 304 receives the control signal 302 and provides digital output (i.e. as a function of the control signal 302) to the DAC 306. The DAC 306 may then convert the digital output to analog output which is output by the digital voltage controller 300 as the output voltage.

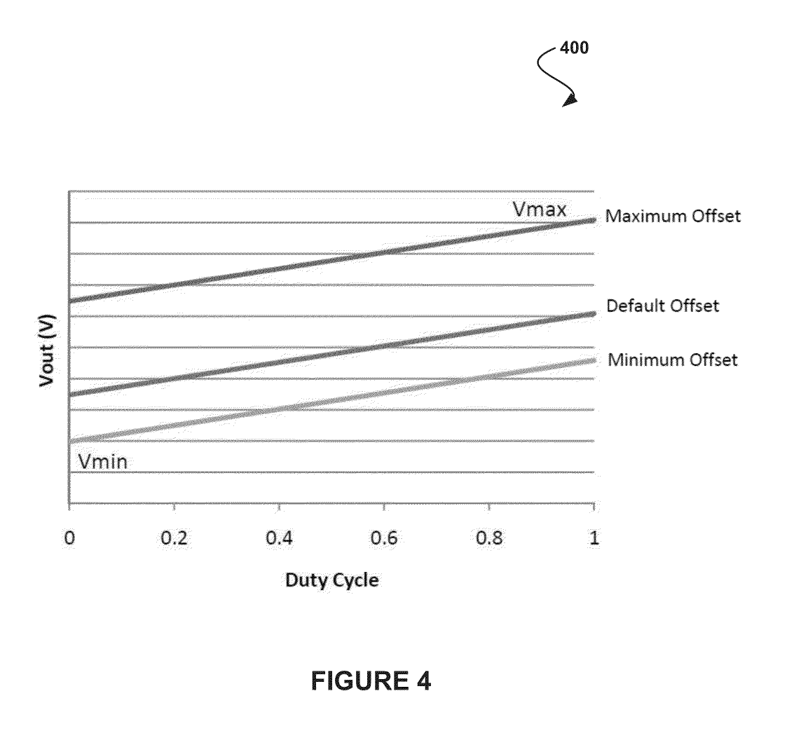

FIG. 4 shows a graphical depiction 400 of output voltage as a function of the control signals duty cycle, in accordance with still yet another embodiment. For example, the graphical depiction 400 of output voltage as a function of control signal duty cycle may represent the operation of the voltage controllers described above with respect to FIGS. 1-3. Again, it should be noted that the aforementioned definitions may apply during the present description.

As shown, the value of the output voltage (Vout) of the voltage controller is a direct function of the percentage (i.e. ratio) of the high time to low time of the duty cycle of the control signal provided to the voltage controller. As the percentage of the control signal increases, the output voltage increases. Thus, the output voltage may be dynamically adjusted by changing the percentage of the control signal duty cycle.

As also shown, the output voltage range may be able to shift by a negative offset (down to minimum offset) or positive offset (up to maximum offset) voltage. The minimum offset is the minimum voltage (Vmin) capable of being achieved by the voltage controller, whereas the maximum offset is the maximum voltage (Vmax) capable of being achieved by the voltage controller.

It should be noted that error may be introduced by various factors, such as tolerance of a voltage supply driving the control signal. However, to control such error, the voltage steps (Vstep) where the duty cycle is very small (i.e. below a predetermined percentage) or very large (i.e. above a predetermined percentage) may be skipped (e.g. such that they are not used in the control signal for generating the output voltage). In this way, the percentage of the duty cycle of the control signal provided to the voltage controller may be limited to a predetermined range, for reducing error in a value of the output voltage.

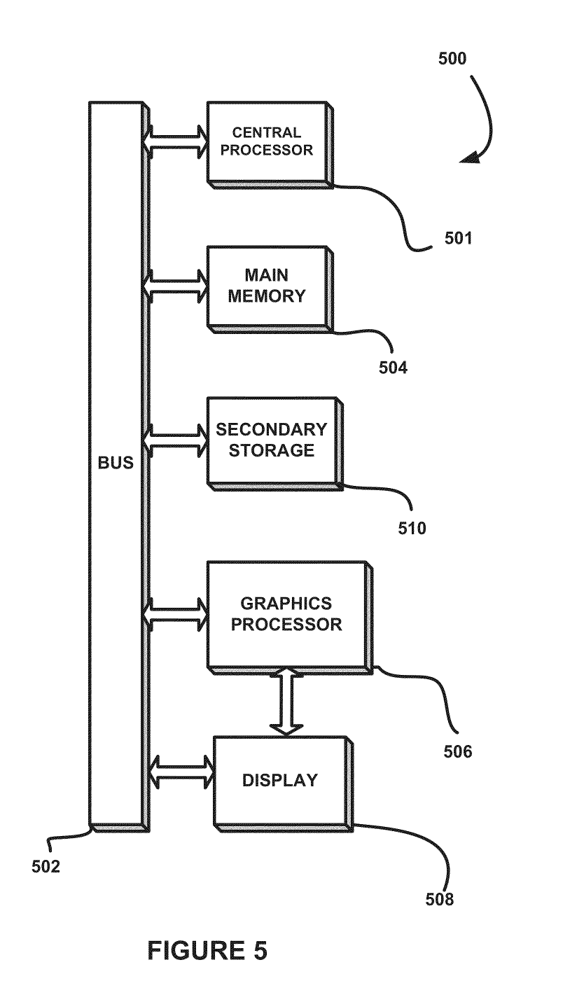

FIG. 5 illustrates an exemplary system 500 in which the various architecture and/or functionality of the various previous embodiments may be implemented. As shown, a system 500 is provided including at least one host processor 501 which is connected to a communication bus 502. The system 500 also includes a main memory 504. Control logic (software) and data are stored in the main memory 504 which may take the form of random access memory (RAM).

The system 500 also includes a graphics processor 506 and a display 508, i.e. a computer monitor. In one embodiment, the graphics processor 506 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 500 may also include a secondary storage 510. The secondary storage 510 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 504 and/or the secondary storage 510. Such computer programs, when executed, enable the system 500 to perform various functions. Memory 504, storage 510 and/or any other storage are possible examples of computer-readable media.

In one embodiment, the architecture and/or functionality of the various previous figures may be implemented in the context of the host processor 501, graphics processor 506, an integrated circuit (not shown) that is capable of at least a portion of the capabilities of both the host processor 501 and the graphics processor 506, a chipset (i.e. a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 500 may take the form of a desktop computer, lap-top computer, and/or any other type of logic. Still yet, the system 500 may take the form of various other devices m including, but not limited to a personal digital assistant (PDA) device, a mobile phone device, a television, etc.

Further, while not shown, the system 500 may be coupled to a network [e.g. a telecommunications network, local area network (LAN), wireless network, wide area network (WAN) such as the Internet, peer-to-peer network, cable network, etc.) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A system, comprising:
a device in communication with the voltage controller via a single wire for use by the device in controlling an output voltage of the voltage controller.

2. The system of claim 1, wherein the device is a graphics processor.

3. The system of claim 1, wherein the voltage controller is an analog voltage controller.

4. The system of claim 1, wherein the voltage controller is a digital voltage controller.

5. The system of claim 1, wherein voltage controller includes a switch controlled by the device via the single wire.

6. The system of claim 5, wherein the switch toggles a reference voltage.

7. The system of claim 6, wherein the reference voltage is provided by an external voltage reference or a voltage reference of a voltage regulator.

8. The system of claim 6, wherein the switch toggles the reference voltage according to a control signal provided by the device via the single wire.

9. The system of claim 1, wherein the voltage controller includes a buffer.

10. The system of claim 9, wherein the buffer toggles a reference voltage.

11. The system of claim 1, wherein a sub-component of the voltage controller is a voltage regulator.

12. The system of claim 1, wherein the device controls the output voltage of the voltage controller using a control signal communicated over the single wire.

13. The system of claim 12, wherein the control signal includes a pulse width modulation signal that controls the output voltage according to a duty cycle.

14. The system of claim 12, wherein the control signal includes a modulated signal that controls the output voltage according to a percentage on/off time.

15. The system of claim 13, wherein a value of the output voltage is obtained as a function of a percentage of the duty cycle of the control signal.

16. The system of claim 13, wherein the output voltage (Vout) is controlled by:
Vout=Vmin+N*Vstep
where:
Vmin is a minimum voltage at a zero percent control signal duty cycle,
N is a number of voltage steps at the output voltage, where the number of voltage steps is from zero towards a maximum number of available voltage steps, and
Vstep is a resolution of each of the voltage steps.

17. The system of claim 16, wherein the device can adjust the resolution of each voltage step.

18. The system of claim 15, wherein the percentage of the duty cycle of the control signal provided to the voltage controller is limited to a predetermined range, for reducing error in a value of the output voltage.

19. A method, comprising:
receiving, at a voltage controller, a control signal from a device via a single wire; and
controlling an output voltage of the voltage controller using the received control signal.

20. The method of claim 19, wherein the device is one of a graphics processing unit or a central processing unit.
